(19) United States
(12) Patent Application Publication
(10) Pub. No.: US 2006/0023626 A1
(43) Pub. Date: Feb. 2, 2006

(54) System and method for preventing loss of personal items

(76) Inventor: Manuel Krausz, Brooklyn, NY (US)

Correspondence Address: OSTROLENK FABER GERB & SOFFEN, 1180 AVENUE OF THE AMERICAS, NEW YORK, NY, 100368403, US

(21) Appl. No.: 10/901,871

(22) Filed: Jul. 29, 2004

(51) Int. Cl. H04J 3/14

(52) U.S. Cl. 370/220

(57) ABSTRACT

Disclosed is a system and method for preventing misplacement of personal items. The invention comprises a master communication device that automatically and repeatedly transmits at least one signal over a transmission range, and at least two slave communication devices, each of which are configured to be associated with a respective personal item and to communicate periodically with the master communication device. At least one of the master and slave communication devices generates a notification alerting a user that at least one of the at least two slave communication devices has not received the signal.

### FIELD OF INVENTION

The present invention relates generally to systems and devices for preventing loss of personal objects, and, more particularly, to a system and method for ensuring that portable items are kept on or about a person.

### BACKGROUND OF THE INVENTION

For generations, people have struggled to keep personal goods and effects close in hand. Keys, wallets, glasses, watches, jewelry and personal items are sorely missed when they are stolen, or accidentally forgotten or misplaced, sometimes at great financial loss. Technological developments over recent decades have added various forms of personal technology, including cellular telephones, digital messaging devices, compact audio players, remote-control devices, calculators, miniature dictating machines and personal digital assistants (“PDAs”) to the inventory of items kept close to one's person. Many people worry on a daily basis about losing or misplacing an essential personal item.

Devices are currently available to assist people in finding items once they have become lost or misplaced. One prior art device comprises a miniaturized coded transmitter and battery powered receivers that respond to predetermined code transmissions. Personal goods and effects are coupled to the receivers which, for example, give an audible signal when interrogated by a transmitter. The locations of each personal good can be determined by the audible signal generated from the receiver coupled to each personal good

U.S. Pat. No. 4,476,469 to Lander provides a “Means for Assisting in Locating an Object.” The patent discloses a hand-held “searcher” device having electronic circuitry for generating an “address signal” when activated by switching means. A miniature “locator” comprises electronic circuitry to receive a signal transmitted from the searcher. The searcher may be provided with circuitry and selective switching means for selectively addressing several locators which may be placed with or on respective objects or attached thereto, e.g. by means of a small ring. The patent further discloses transmitter-to-transponder signaling by using airwaves, vibrations or by electromagnetic waves, preferably employing pulse position modulation. Thus, the patent purportedly enables a person to find a misplaced item by using the searcher and locator.

U.S. Pat. No. 6,674,364 (the “'364 patent”) to Hollbrok et al. provides an “object finder.” The '364 patent discloses a wireless transmitter that produces a unique digital signal or data packet to be received by a codable wireless receiver. The coded receiver emits an audio signal or sound from a sound generating device for locating the misplaced object. The '364 patent enables people to locate several commonly misplaced objects or items having receivers attached thereto. The '364 patent solves the problem of using a single transmitter to locate multiple receivers, each coded with unique address. Further, the object finder of the '364 patent uses digital coding which avoids system interference common to analog systems. Moreover, the receivers are sufficiently small sized to be placed conveniently on various articles.

The '364 patent discloses specific transmitter serialization provided by a network of resistors and capacitors, providing a microcontroller having a RAM, thereby eliminating the need for a separate memory chip. The network includes six resistors and from one up to six capacitors, providing 63 different transmitters, each having a unique ID by removal of one or more of the capacitors when the transmitter is manufactured. Even with as many as 12 components, the object finder is relatively inexpensive to manufacture compared to the cost of manufacturing a memory chip.

Referring now to drawing figures in which like reference numerals refer to like elements, FIGS. 1A and 1B illustrate a prior art schematic wiring diagrams of the transmitter module disclosed in the '364 patent, and corresponds with FIG. 8 of the '364 patent. FIG. 2 illustrates a prior art schematic wiring diagram of the receiver module, disclosed in the '364 patent and corresponds with FIG. 9C of the '364 patent. Column 7, lines 30 to 52 include the following description of the transmitter circuit:

“The transmitter circuit as shown in [FIGS. 1A and 1B] includes a digital section A for generating a digital data packet and a radio frequency (RF) section B for broadcasting the packet to receivers. Upon a user's request via a button press in the digital section A, a digital signal or data packet from the digital section corresponding to the button pressed is sent to the RF section, and an LED circuit in the digital section A is turned on to energize the LED 75 and produce a visual signal indicating a data packet signal was produced. The RF section is turned on and will then broadcast the data packet which includes, as above mentioned, a header, a receiver address, and a transmitter ID. The header is always first in the packet for waking up the receiver so that the receiver can then compare the remainder of the packet.”

“The digital section labeled ‘A’ consists of a microcontroller or controller 70 having both a RAM and a ROM, a 32.7681 kHz (kiloHertz) system clock 72 connected to the microcontroller, a three-volt power source provided by two AAA alkaline batteries in series, a transistor for turning on the LED, coils, resistors, capacitors, switches, a piezo transducer 74 and the LED 75. The values for the resistors, capacitors and coils are shown on the drawings, as well as the type of microcontroller employed.”

Column 9, lines 50 to 57 include the following description of the receiver circuitry:

“The receiver circuitry shown in [FIG. 2] includes an RF section C for receiving a transmission of a data packet from the transmitter, an amplifier B for amplifying the data packet transmission, and a digital section A for comparing the data packet to that stored in the RAM of the microcontroller. If the data packet compares to the stored data packet, the controller will trigger the sound generator in the form of a piezo transducer.”

Furthermore, column 10, lines 49-56 describe the microcontroller to check battery status:

“The microcontroller of the receiver will also check the battery status each day. If the battery voltage drops below 2.6 volts, the receiver acknowledges tone changes as described above. When the microcontroller of the receiver measures a battery voltage of 2.4 volts or less, the microcontroller will beep every 20 mS until the voltage source drops below the minimum operation voltage of 1.8 volts for the microcontroller.”

Thus, systems comprising a single master communication device that is capable of providing unique coded signals to be received by respective slave communication devices are known in the art. Further, monitoring battery status in such systems is also known in the art.

The above typical prior art object locators operate similarly by enabling users to locate items and goods that have been misplaced or forgotten. Such prior art locator systems, however, do not help people to prevent misplacing or losing objects in the first place. A remote locator device, such as that disclosed in the '364 patent, is of little use to a person who has unintentionally left an object, such as a PDA or cell phone, at the office or at home.

Systems have been developed that attempt to prevent the loss of children. For example, U.S. Pat. No. 4,853,692 (the “'692 patent”) provides an “infant security system” that is designed to prevent a kidnapper from absconding with an infant from a hospital maternity ward. For example, infants in a hospital maternity ward are supplied with a small RF transmitter capable of transmitting a plurality of coded signals. A corresponding remote RF receiver is associated with each transmitter and tuned to receive a respective transmitted coded signal. Every few seconds the RF transmitter transmits a coded RF pulse. An alarm is sounded if an infant with an attached RF transmitter is removed beyond some predetermined minimum distance from its associated RF receiver. If the transmitted signal from being received by the RF receiver, an alarm is likewise triggered. The RF transmitter and receiver function to insure that (1) the RF transmitter remains attached to the infant and (2) the infant and the attached RF transmitter remain in the proximity of the corresponding receiver.

U.S. Pat. No. 6,331,817 (the '817 patent) to Goldberg provides an “Object Tracking Apparatus and Method” that includes an organizer that stores information regarding a set of objects to be tracked in a plurality of environments in response to one or more events. For example, using BLUETOOTH technology, an event that triggers tracking is the physical environment where the organizer is determined to be. When the organizer is in an automobile, for example, various devices associated with the automobile are interrogated. Other events to trigger tracking include a particular day of the week, the time of day, or actuation of a trigger switch 302. In response to an event, the organizer tracks objects associated in the set.

The devices disclosed in the '692 patent, the '364 patent and the '817 patent suffer from various drawbacks. For example, the infant security system operates monitors only a single receiver communication device, and cannot distinguish between slave communication devices. Further, the infant security system is not adaptable for personal items and effects that travel about with a person. The object tracking method of the '817 patent requires an event to occur prior to tracking. By the time the event occurs, the very item to be tracked may already be gone.

The above-identified United States patents are incorporated herein, by reference.

### SUMMARY OF THE INVENTION

A need exists for a system that prevents the loss or theft of personal items which are typically kept on or about one's body. The present invention provides a system for preventing loss or misplacement of personal items without the need for a triggering event, such as an actuation of a switch, to determine whether an item has been misplaced, lost or stolen.

In an example embodiment, the present invention comprises a master communication device that automatically and repeatedly transmits at least one signal over a transmission range, and at least two slave communication devices, each which is configured to be associated with a respective personal item and to communicate periodically with the master communication device. The master communication device, the slave communication device, or both generates a notification alerting a user that at least one of the at least two slave communication devices has not received the signal.

In addition, the at least two slave communication devices are further configured to receive the signal from the master communication device and to transmit a response signal to the master communication device after the signal is received from the master communication device.

Moreover, the slave communication devices are configured to transmit the response signal to the master communication after a respective period of time passes once the signal is received from the master communication device.

Additionally, the master communication device is configured to determine which slave communication device has transmitted a response signal by measuring the amount of time that passes between transmitting the signal to the slave communication devices and receiving the signal from the slave communication devices. The signals can be radio frequency signals, ultra-sonic frequency signals and/or an infra-red signals. The response signals received from the slave communication devices are preferably coded to represent respective ones of the slave communication devices. Moreover, the transmission range varies for each respective slave communication device.

### BRIEF DESCRIPTION OF THE DRAWINGS

For the purposes of illustrating the invention, there is shown in the drawings a form which is presently preferred, it being understood however, that the invention is not limited to the precise arrangements and instrumentalities shown. The features and advantages of the present invention will become apparent from the following description of the invention that refers to the accompanying drawings, in which:

FIGS. 1A and 1B illustrates a prior art schematic wiring diagram of the transmitter module;

FIG. 2 illustrates a prior art schematic wiring diagram of a receiver;

FIG. 3 is a block diagram illustrating an example embodiment of the present invention and representing a master communication device and slave communication devices coupled to respective personal items;

FIG. 4 is a block diagram illustrating an alternative example embodiment of the present invention and representing a slave communication device and master communication devices coupled to respective personal items; and

FIG. 5 is a flow chart describing set up of the present invention.

### DETAILED DESCRIPTION OF THE PREFERRED EMBODIMENTS

The present invention prevents the loss or theft of personal items which are kept on or about one's body. The present invention alerts a user that he has just lost or has somehow gotten separated from a personal item. For example, the invention relatively instantaneously notifies a user when a pickpocket or thief removes a personal item, such as a piece of jewelry, from the person. In another example, the present invention notifies a user in case a personal item is placed down and the user accidentally walks away from the item. Moreover, a group of items are associated with each other and the present invention notifies the user when one of the items is separated from the group. Prevention of losing or stealing of items is the object of the present invention.

In a preferred embodiment, a master communication device is configured to communicate with two or more slave communication devices that are associated with personal items. The slave communication devices are designed to be coupled with or inserted in personal items. For example, a slave communication device can be attached to the backside of a watch or other piece of jewelry. Thereafter, a user sets up the system to assign slave devices to each personal item which is to be kept in close contact with the others. Once the system is set up, the master device repeatedly polls the assigned devices to ensure that they are virtually always present and accounted for. In case any one personal item gets separated from the group, the user is instantly notified. At least one of the master and slave communication devices generates a notification alerting a user that at least one of the slave communication devices is separated from the group.

In an example embodiment, a user creates a list of items in a master device using a human interface, such as a display screen. The list can be entered, for example, by submitting information in a data entry display screen provided with the master communication device. In such case, a user physically enters descriptions of the personal items into the master device.

Alternatively, internal inventorying features are used to set up the list automatically. For example, simply by placing the master device in close proximity with the slave devices establishes the group of items that are to be kept in close proximity. In this embodiment, the presence of each slave communication device is automatically detected, noted and stored into the master communication device's memory.

Once the system is set up, the master communication device automatically monitors the slave devices by frequently and repeatedly communicating with the slave communication devices. In case the system determines that any one of the items is not in close proximity, for example, because a response signal is not received from the slave device in response to the master communication device's interrogation signal, the user is instantly notified.

In order to differentiate between various slave devices, different identifying tones or signals may be provided to alert a user that an item has been lost. For example, the musical note C represents one slave device, and the note E represents another slave device. Alternatively, one beep represents one slave device and five beeps represents another slave device. Of course, one skilled in the art will recognize that a user can be notified in various ways—single beeps, multiple beeps, vibrations, etc., when an item gets separated from the group. In an example embodiment, the user can elect to temporarily halt a notification, such as by using a snooze feature.

As used herein, the term, “personal” refers generally to items held on or about one's body. For example, items that are carried in one's hand, clothing or near one's body are considered to be personal items.

The present invention provides a system that is simple in construction and convenient to use for preventing misplacement of various items.

Preferably, the system comprises a master communication device that repeatedly transmits a signal to be received by a slave receiving device. In an example embodiment, the signal transmitted is a radio frequency (RF) signal. Of course, other types of signals (e.g., ultra-sonic frequency signals, digital signals, infra-red signals or the like) can be provided. For example, the master communication device may transmit data over a 720,000 M₂ carrier.

In an example embodiment, a master communication device comprising a RF signal generator or any other suitable transmitter automatically and repeatedly sends a signal to one or more slave communication devices. When a slave device that was within a predetermined distance range of the master communication device moves outside that distance range an audible (or visual or other, such as vibrating) notification is generated.

Preferably, the slave communication device is sufficiently small to be mounted in or on a personal item, such as a cellular telephone or PDA or jewelry piece. Further, the master and/or slave communication devices are constructed in forms and use conventional communication components, such as those described above, or being known by those skilled in the art. One or more of the devices are preferably programmable to operate in various ways, for example, to emit various tones and notifications.

Thus, the present invention is configurable in a variety of ways. In one embodiment of the present invention, a master communication device transmits a signal (such as a RF signal or an ultra-sonic frequency signal) to slave communication devices that are configured to receive the signal periodically, for example, every few seconds (e.g., every 2 seconds). The slave communication device is preferably coupled to a personal item, such as a cellular telephone. If the slave communication device is out of range of the signal, then the slave communication device notifies the user, for example, by emitting an audible tone. In an alternative embodiment, the slave communication device comprises a transceiver and sends an acknowledgement that the transmitted signal has been received. If, after a brief time, the acknowledgement signal is not received by the master communication device, then the master communication device notifies the user. In yet another example embodiment, both the master communication device 102 and the slave communication device 104 notify the user when a signal is not received. In yet another embodiment, the slave communication device 104 transmits a signal to the master communication device 102 when a signal is not received. Thus, the terms, “master communication device” and “slave communication device,” as used herein are not meant to limit or restrict the invention to devices that are limited to transmitting or receiving, respectively.

In a preferred embodiment of the present invention, the master device transmits a signal to the slave devices, and the slave communication devices are programmed to transmit a signal to the master communication device in response. Each slave communication device waits a respective amount of time before transmitting its response. For example, a first slave communication device is programmed to respond to the master communication device in 5 milliseconds, and a second slave communication device is programmed to respond in 10 milliseconds. The master communication device is programmed with the slave communication devices' respective response times. Accordingly, by measuring the amount of time between sending an initial transmission to slave communication devices and receiving replies therefrom, the master communication device can determine which slave communication devices have responded.

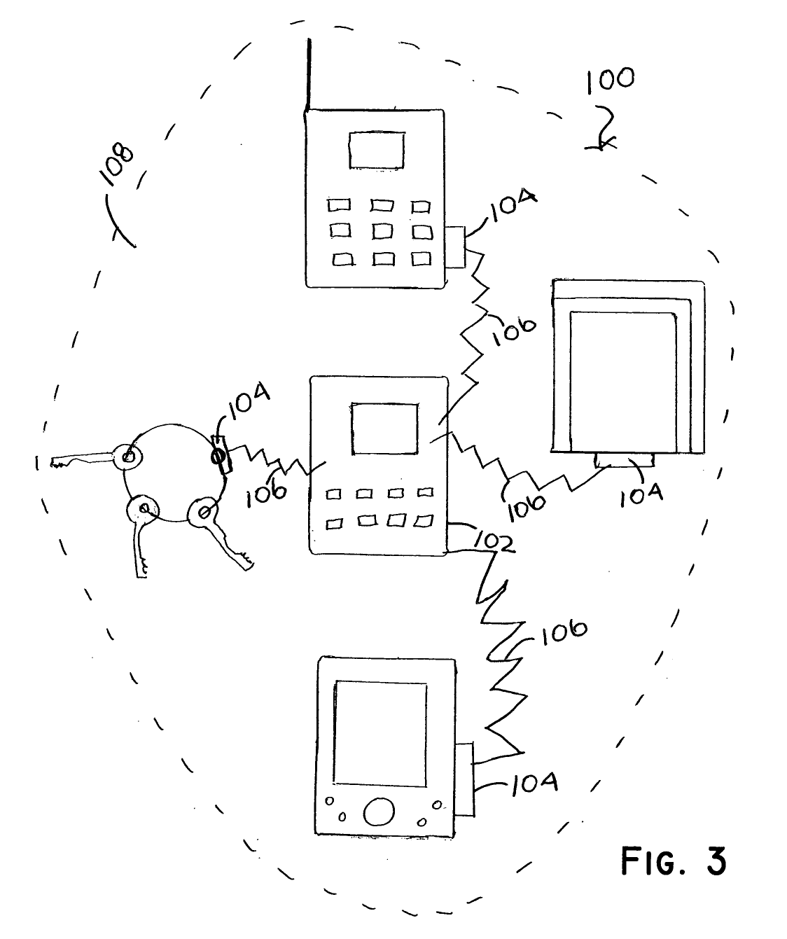

FIG. 3 illustrates an example embodiment of the present invention including arrangement of personal items, slave communication devices and a master communication devices and referred to herein, generally, as system 100. As shown in FIG. 3, master communication device 102 communicates with respective slave communication devices 104 in the form of respective signals 106. Dotted line 108 represents a physical range in which transmissions of signals 106 can be received by slave communication devices. Beyond range 108, the slave communication devices are unable to receive signals 106. Alternatively, the master communication device 102 determines the range or separation distance to the slave devices 104, for example, by range finding as in cameras or by measuring the elapsed time from transmitting an interrogation signal to the receipt of response from the slave devices.

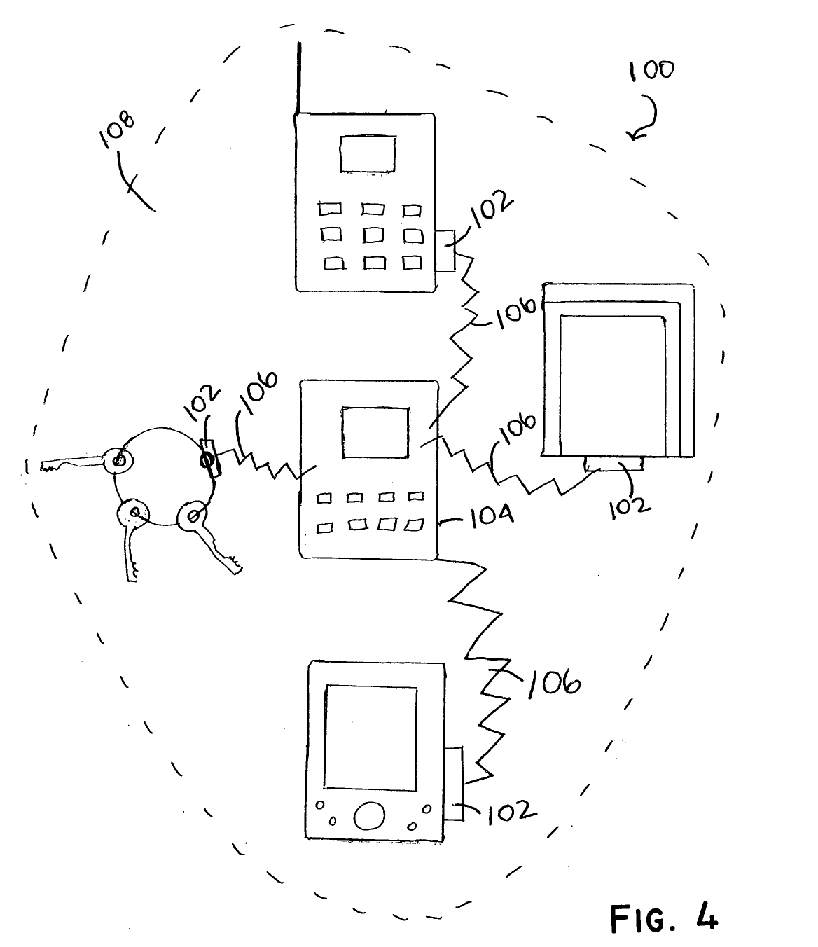

FIG. 4 is a block diagram illustrating an alternative example embodiment of the present invention and representing a single slave communication device 104 and master communication devices 102 that are coupled to respective personal items. In this alternative example embodiment, the master communication devices 102 automatically and repeatedly transmit signals 106 to the slave communication device 104. Slave communication device 104 is configured to expect signals 106 from the respective master communication devices 102 and to generate a notification to a user in the event that a signal 106 is not received from a master communication device 102.

As noted above, use of the terms slave communication device and master communication device is for explanatory purposes. In yet another example embodiment of the present invention, the transmitter and slave communication devices both comprise transceivers and are capable of sending and receiving transmissions 106.

Unlike prior art object locator devices, the present invention is advantageous because no manual search function is required of the user to locate items. Instead, the master communication device 102 repeatedly polls the slave communication devices 104 with signals 106 which, in one embodiment, are configured to respond if the signal is not received.

The present invention operates in a one-to-many environment. In other words, a single master communication device 102 operates with a plurality of slave communication devices 104. The present invention is an improvement over prior art locator systems due to the small design of the respective components, and automatic polling of the components to prevent loss of items.

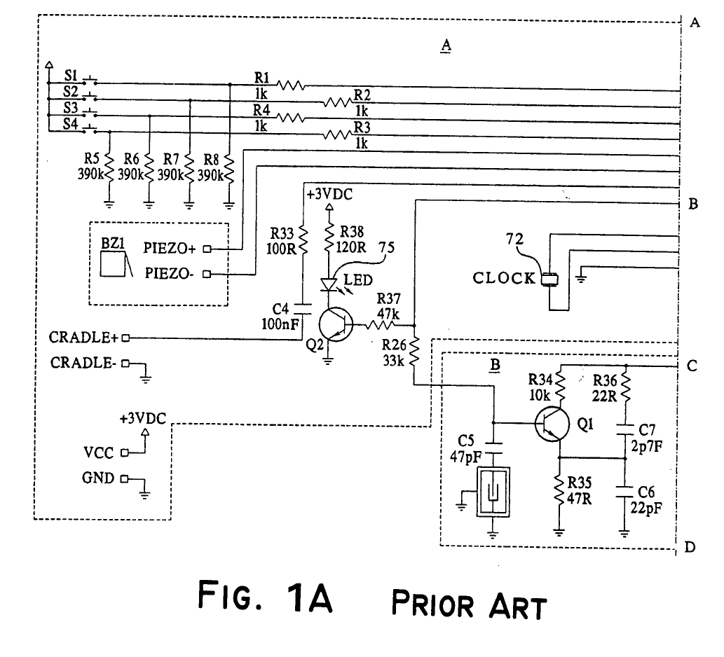

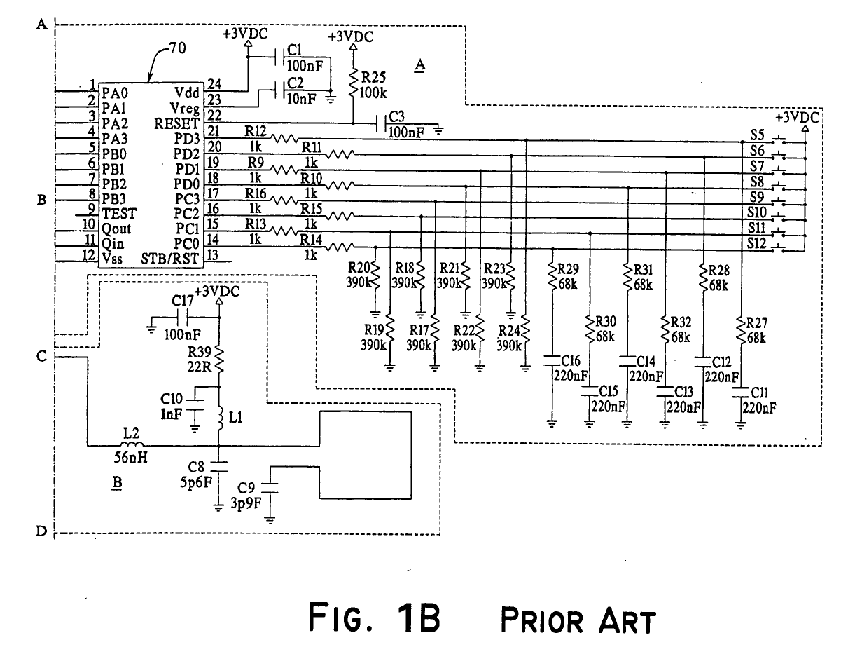

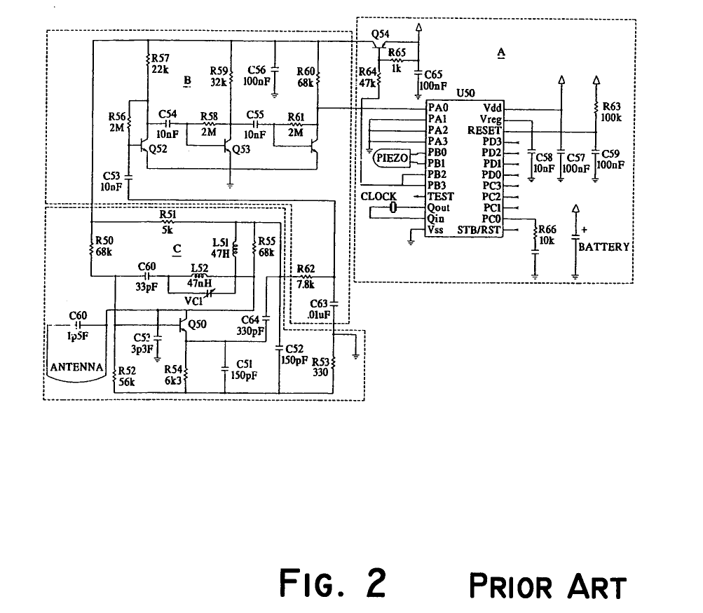

In a preferred embodiment, the master communication device 102 comprises components similar to those illustrated in the schematic shown for the prior art transmitter and illustrated in FIGS. 1A and 1B. Unlike the transmitter of FIGS. 1A and 1B, however, no user request is necessary for the present invention to function. Instead, and as noted above, the master communication device is programmed to automatically poll the slave communication devices in order to prevent loss of items. Further, slave communication device 104 comprises components, as illustrated in FIG. 2.

In operation, when the master communication device and slave communication devices are within range 108, the system is in a ready “default” state. In an example embodiment, the master communication device 102 repeatedly sends out a signal that, if not received by a slave communication device 104, causes the master communication device 102 and/or slave communication device 104 to produce an audible, visible or other type of signal. In an example embodiment of the present invention, a slave communication device 104 is attached to a personal item, such as a cellular telephone, and when the item is out of range of the master communication device 102, a short notification, such as three short chirps, is provided to alert the person that the item is out of range. Periodic single short chirps may be provided as long as the system is out range. When the item is brought back within range, the notification stops and, the system is reset. Thus, the next time the item is out of range, it chirps three times again.

In an example embodiment of the present invention, the slave communication devices 104 are formatted as tags that are very simple to produce and use. Preferably, the tags are quite small, for example, about ½ inch wide, ½ inch long and ¼ inch thick. The tags can be embedded in the personal item, or can be adhered to the item, for example, by VELCRO or another adhesive means.

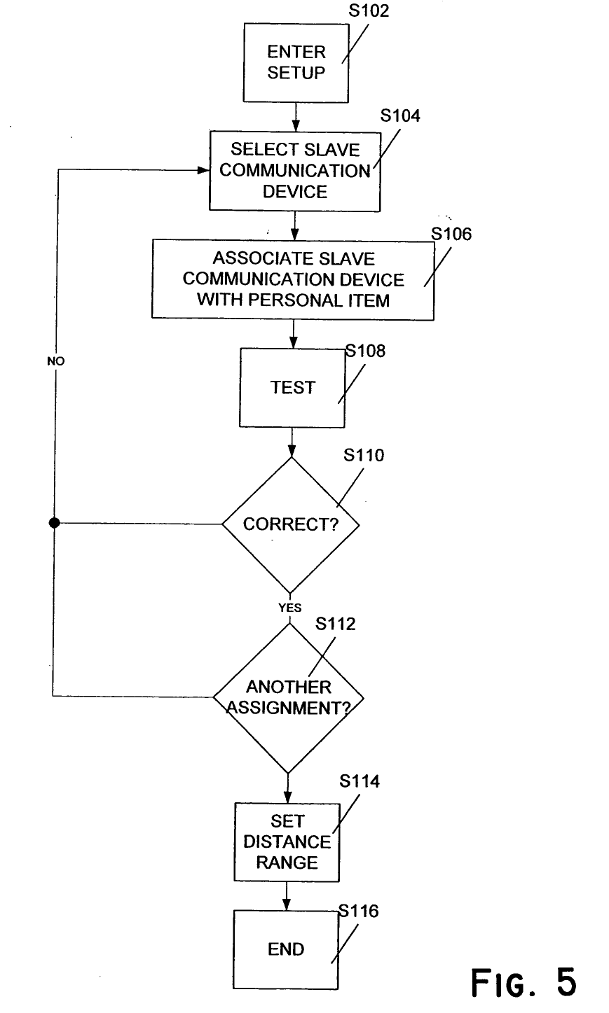

In a preferred embodiment of the present invention, the master communication device 102 comprises a user interface to identify the items that are associated with respective slave communication devices 104. FIG. 5 is a flow chart illustrating the steps associated with configuring the master communication device 102 for operation. In step S102, the user selects a set up and configuration mode, for example, by selecting a button on the master communication device 102 labeled MENU. The user navigates the user interface to associate the slave communication devices 104 with respective personal items. For example, in step S104, the user selects an individual slave communication device 104 for association. In step S106, the user enters the name of a personal item that is identified with the slave communication device 104. For example, the user may use a data entry feature to type or otherwise enter the name of the item. Alternatively, the user may select from a list of common personal items and select the particular item from list. In step S108, the user can perform an optional test to ensure that the correct slave communication device 104 is associated with the particular item. In step S110, if the test results are correct, the flow continues to step S112, otherwise the process loops back to step S104. In step S112, the user can elect whether to configure another device, in which the process loops back to step S104, or whether to continue the setup process in step S114. In step S114, the user can, optionally, define a distance for range 108. For example, the user can select from a list an appropriate value, such as 1 meter, 2 meters or the like, that represents the distance of range 108. When the user is satisfied with the selections, he selects a choice to complete the setup and the process ends at step S116.

In an alternative embodiment from the flow chart shown in FIG. 5, each respective slave communication device may be configured to receive transmissions within a specific range. For example, a person may define a transmission range for a piece of jewelry which the person desires to always keep on his person to be two meters. The person may define a transmission range for a notebook computer to be 3 meters. Thus, the invention supports improved functionality over prior art locator devices by providing for definable transmission ranges for individual items.

In the same or yet another example embodiment of the present invention, the master communication device 102 comprises a display screen that notifies the user when a slave communication device associated with an item is out of range 108 or otherwise not communicating with the master communication device 102. For example, when the slave communication device associated with a personal digital assistant is out of transmission range 108, the display on the master communication device 102 shows “PDA is out range.” The user can, at a glance, determine which item is out of range 108 (or otherwise not responsive) to prevent misplacing or losing the item.

Thus, the present invention prevents a person from having to search and locate items that are already lost or misplaced. Instead, the present invention functions to prevent personal items, such as items that are kept on or about the body, from being misplaced, forgotten, stolen or the like. Too often, a person uses a cellular telephone, for example, at a bank, and puts the phone down for a moment only to later forget to pick it up. Continuing with the present example, the present invention provides a notification (e.g., an audible tone) to the person at the bank before the phone gets left behind. The present invention eliminates the worry and inconvenience of losing personal items.

Preferably, components of the present invention are programmable such that PDA's, cellular telephones audio players or the like are easily identified when out of range of the master communication device 102. In an alternative embodiment of the present invention, the personal devices themselves may be equipped with master communication devices 102 and/slave communication devices 104, thereby alleviating the need to attach a separate component to a personal device. For example, a cellular phone can include the components of a slave communication device 104 and, therefore, comprise all of the functionality provided by a slave communication device 104.

In an example embodiment of the invention, slave communication devices 104 and the master communication device 102 can be set in a sleep mode to prevent notification when one or more receivers are taken out of range of the transmitter. For example, when a person retires for the evening, he may not wish to be notified each time his PDA is out of range 108. Accordingly, the system can be temporarily suspended, and reactivated at will. Alternatively, a person can bypass an individual slave communication device 104 so that the person is not alerted when the personal item associated with that slave device 104 is out of range 108. For example, a person loans his cellular telephone having a slave communication device 104 coupled thereto to another person. By temporarily suspending operation of that slave communication device 104, the cellular telephone can be taken out of range 108 without a notification being provided. Optionally, the master communication device 102 can alert a person periodically that one or more slave communication devices 104 has been temporarily disabled.

In the same or yet another embodiment, after a notification is provided to a person, the person can temporarily halt future notifications, for example, as provided by a snooze feature in an alarm clock. Still further, the master communication device 102 may be set up to provide a single audible warning that a personal item has been left behind. The different personal items can be identified by different tones.

Thus, the present invention provides benefits over prior art locator devices. Other features and uses of the present invention will become readily apparent to one skilled in the art. For example, the slave communication devices can be configured to distinguish between a low battery signal from the transmitter from being out of range 108. Further, a clock mechanism, such as disclosed in the '364 patent can be incorporated into the master communication device 102 and slave communication devices 104 to monitor and/or preserve battery life.

Also, the master communication device 102 may be equipped with a base or other station that includes a finding function, similar to that described in the '364 patent, such that if the master communication device 102 is misplaced, it can be located.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed:

1. A system for preventing misplacement or loss of personal items, the system comprising:
a master communication device that automatically and repeatedly transmits at least one signal over a transmission range; and
at least two slave communication devices, each of the at least two slave communication devices configured to be associated with a respective personal item and to communicate periodically with the master communication device, wherein at least one of the master and slave communication devices generates a notification alerting a user that at least one of the at least two slave communication devices has been separated from the master communication device by greater than a predetermined distance.

2. The system of claim 1, wherein the at least two slave communication devices are further configured to receive the at least one signal from the master communication device and to transmit a signal to the master communication device after the at least one signal is received.

3. The system of claim 2, wherein the at least two slave communication devices are configured to transmit the signal to the master communication after a respective period of time passes after the at least one signal is received from the master communication device.

4. The system of claim 3, wherein the master communication device determines which of the at least two slave communication devices has transmitted the signal by measuring an amount of time from transmitting the at least one signal to the at least two slave communication devices to receiving the signal from the at least two slave communication devices.

5. The system of claim 1, wherein the at least one signal is at least one of a radio frequency signal, an ultra-sonic frequency signal and an infra-red signal.

6. The system of claim 1, wherein the at least one signal is coded to represent respective ones of the at least two slave communication devices.

7. The system of claim 1, wherein the transmission range varies for each respective at least two slave communication devices.

8. The system of claim 1, wherein at least one of the master communication device and the at least two slave communication devices are configured to stop functioning for a temporary period.

9. The system of claim 1, including a software facility within the master communication device that automatically recognizes the presence of a slave communication device located within the predetermined distance of the master communication device.

10. The system of claim 1, including a tracking software facility within the master communication device that keeps track of all slave communication devices which are within the predetermined distance of the master communication device.

11. The system of claim 10, in which the tracking facility removes a slave communication device that has been separated away from the master communication device and has not responded to communications from the master communication device for a given time period or by a distance greater than said predetermined distance.

12. The system of claim 1, in which the notification is additionally generated when the master communication device determines that it has been separated from at least one of the slave communication devices by a greater than a predetermined distance.

13. The system of claim 12, in which the master communication device determines the distance between itself and the slave communication devices by range finding.

14. A method for preventing misplacement of personal items, the method comprising:
automatically and repeatedly transmitting at least one signal over a transmission range to a plurality of slave communication devices;
associating each of the plurality of slave communication devices with a respective personal item;
communicating periodically between the master communication device and the slave communication devices; and
generating a notification alerting a user that at least one of the at least two slave communication devices has not received the signal.

15. The method of claim 9, further comprising receiving the at least one signal from the master communication device and transmitting a signal to the master communication device after the at least one signal is received.

16. The system of claim 10, wherein the step of transmitting the signal to the master communication occurs after a respective period of time passes after the at least one signal is received from the master communication device.

17. The method of claim 11, further comprising determining by the master communication device which of the at least two slave communication devices has transmitted the signal by measuring an amount of time from transmitting the at least one signal to the at least two slave communication devices to receiving the signal from the at least two slave communication devices.

18. The method of claim 9, wherein the at least one signal is at least one of a radio frequency signal, an ultra-sonic frequency signal and an infra-red signal.

19. The method of claim 9, further comprising coding the at least one signal to represent respective ones of the at least two slave communication devices.

20. The method of claim 9, further comprising defining respective transmission ranges for each respective at least two slave communication devices.

21. The method of claim 9, further comprising configuring at least one of the master communication device and the at least two slave communication devices to stop functioning for a temporary period.
